(19) United States
(12) Patent Application Publication
(10) Pub. No.: US 2010/0199562 A1
(43) Pub. Date: Aug. 12, 2010

(54) LOUVER WITH TILT ROD BEING DISPOSED IN A NON-PROTRUSION POSTION AFTER CLOSING.

(76) Inventor: NENG-YU YANG, Tainan (TW)

Correspondence Address: Neng - Yu Yang, No. 125, Hsin-Tien 2nd Street, Jeng-Teh, Tainan, 717, TW

(21) Appl. No.: 12/699,903

(22) Filed: Feb. 4, 2010

(30) Foreign Application Priority Data
Feb. 9, 2009 (TW) 098201848

(51) Int. Cl. E06B 7/086

(52) U.S. Cl. 49/92.1; 49/74.1

(57) ABSTRACT

One embodiment of a louver for installation in an opening in a wall includes a head; a sill; two opposite iambs wherein one iamb has a longitudinal recess; a plurality of parallel sloping slats disposed in a space defined by the head, the sill, and the iambs, each slat being pivotably secured to the jambs; and a tilt rod pivotably secured to the slats. The tilt rod is received in the recess when the louver is closed.

### BACKGROUND OF THE INVENTION

1. Field of Invention

The invention relates to window louvers and more particularly to a louver having a tilt rod which is disposed in a non-protrusion position after closing so as to be aesthetic.

2. Description of Related Art

A typical shutter 10 mounted on either side of a window is shown in FIGS. 1 to 3. Each shutter 10 has a single louver and is pivotably secured to the exterior of the window by two hinges 14. Each shutter 10 comprises a rectangular frame 11 having opposite jambs with a plurality of horizontal sloping slats 12. Each slat 12 has two opposite ends extending between the jambs and a pivot pin 15 extending through a transverse central line to pivotably secure to the jambs. The shutter 10 further comprises a tilt rod 13 which is attached to centers of the inner edges of the slats 12 by means of two interconnecting U-shaped nails 16. Hence, a movement of the tilt rod 13 will impart simultaneous pivotal movement to all of the slats 12.

However, a number of disadvantages of the typical shutters 10 have been found. For example, the inwardly projecting tilt rod 13 is not aesthetic. Further, the nails 16 can become detached or pull out of either the tilt rod 13 or the slat 12 due to rust or prolonged period of us. Furthermore, dirt may accumulate on the nails 16 and the tilt rod 13 and it is difficult of cleaning dirt. Hence, the functionality of the tilt rod 13 is impaired. Thus, the need for improvement still exists.

### SUMMARY OF THE INVENTION

It is therefore one object of the invention to provide a louver for installation in an opening in a wall comprising a head; a sill; two opposite iambs wherein one iamb has a longitudinal recess; a plurality of parallel sloping slats disposed in a space defined by the head, the sill, and the iambs, each slat being pivotably secured to the iambs; and a tilt rod pivotably secured to the slats, wherein the tilt rod is received in the recess when the louver is closed.

The above and other objects, features and advantages of the invention will become apparent from the following detailed description taken with the accompanying drawings.

### BRIEF DESCRIPTION OF THE DRAWINGS

FIG. 1 is a perspective view of two typical shutters each hingedly mounted on the exterior of a window and being open;

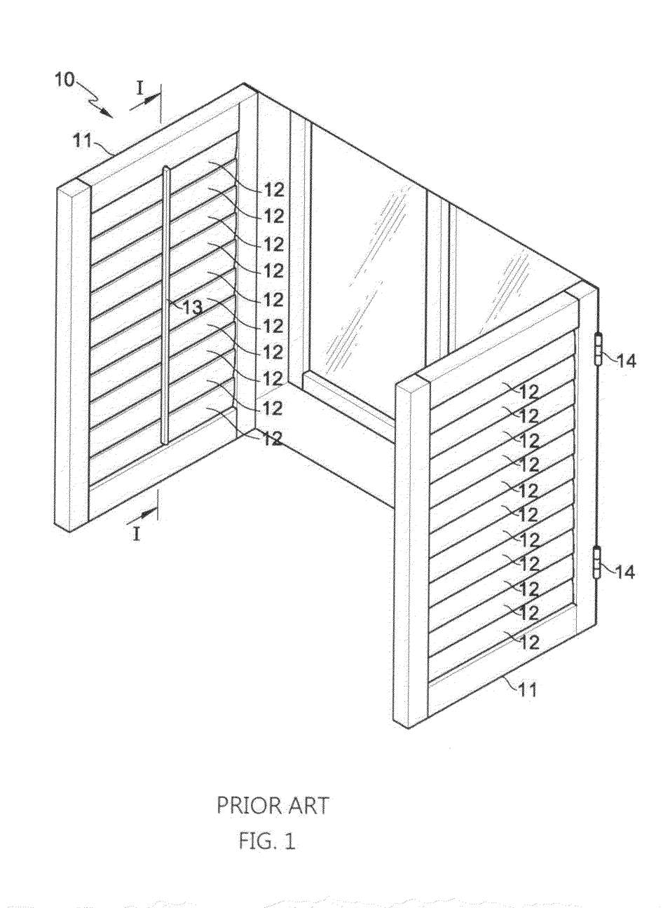

FIG. 2 is a sectional view taken along line I-I of FIG. 1 with the slats being pivoted to an open position;

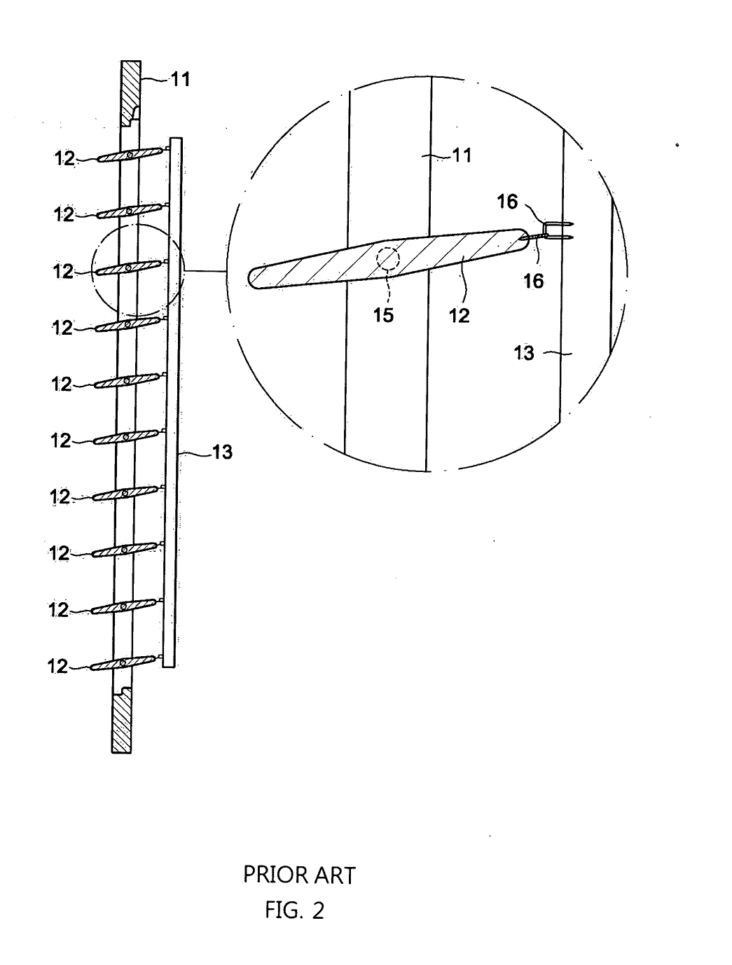

FIG. 3 is a view similar to FIG. 2 with the slats being pivoted to a closed position;

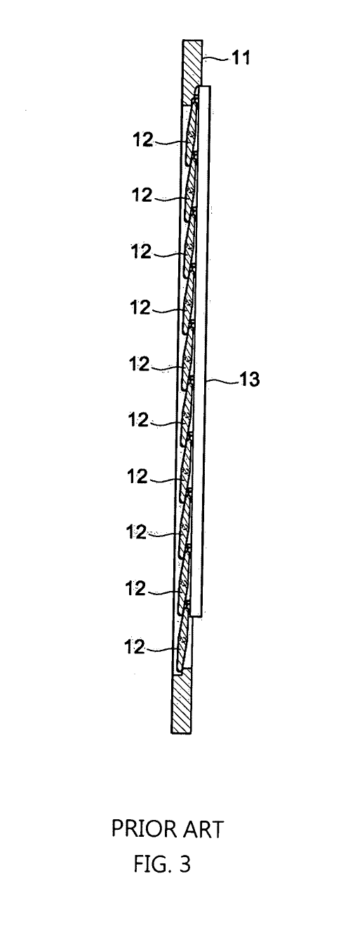

FIG. 4 is an exploded perspective view of a louver according to a first preferred embodiment of the invention;

FIG. 5 is a front view of the louver of FIG. 4 being closed;

FIG. 6 is a sectional view taken along line II-II of FIG. 5;

FIG. 7 is a sectional view taken along line III-III of FIG. 5 with the slats being pivoted to a closed position;

FIG. 8 is a view similar to FIG. 7 with the slats being pivoted to an open position;

FIG. 9 is an exploded perspective view of a louver according to a second preferred embodiment of the invention;

FIG. 10 is a front view of the louver of FIG. 9 being closed; and

FIG. 11 is a detailed view of the area in circle B in FIG. 10.

### DETAILED DESCRIPTION OF THE INVENTION

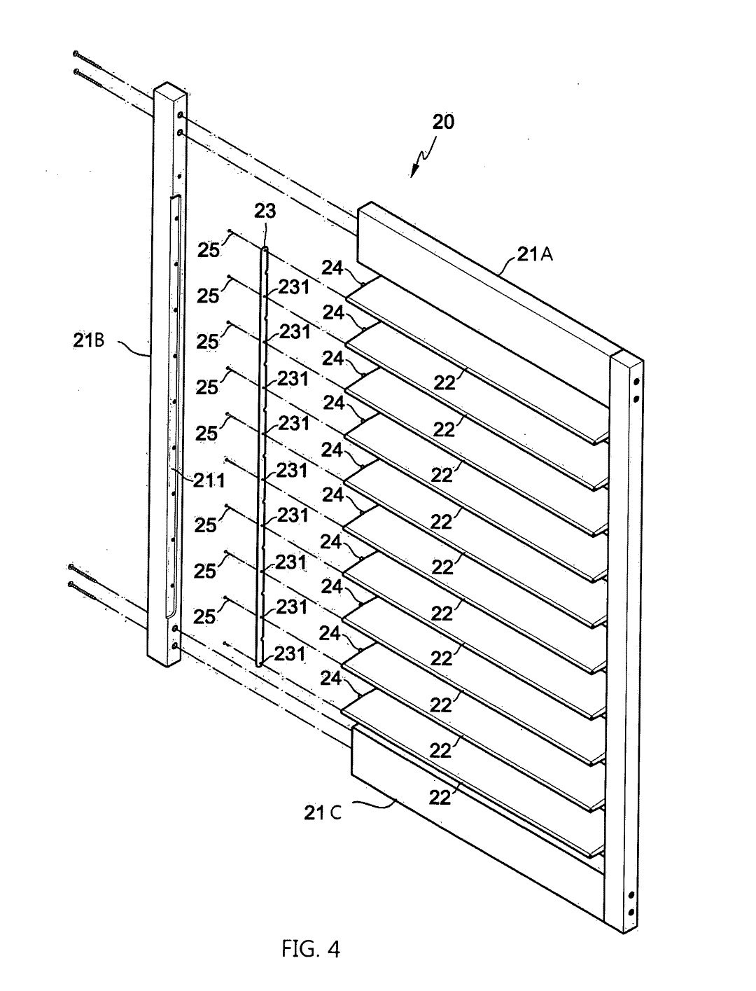

Referring to FIGS. 4 to 8, a louver 20 in accordance with a first preferred embodiment of the invention comprises the following components as discussed in detail below.

A head 21A and a sill 21C each has a cross-section of rectangle. Two opposite iambs 21B each has a cross-section of rectangle. Each jamb 21B has a bottom end threadedly secured to either end of the sill 21C. The head 21A, the sill 21C, and the iambs 21B consist of a frame of the louver.

One jamb 21B has a longitudinal recess 211 on one of four corners facing inward and the other jamb 21B. A plurality of parallel sloping slats 22 are disposed in a space defined by the head 21A, the sill 21C, and the iambs 21B. Each slat 22 has two opposite ends extending between the iambs 21B with a minimum gap between either end and the iamb 21B so as to allow a pivotal movement of the slat 22, and two opposite pivot pins 24 each pivotably disposed in either end of the slat 22 and fastened into an adjacent one of the iambs 21B. As a result, the slats 22 are pivotal about the lambs 21B.

A vertical metal tilt rod 23 is a rectangular piece and is disposed in the interior of a window. The tilt rod 23 comprises a plurality of holes 231 being equally spaced apart therealong. The number of the holes 231 is the same as that of the slats 22. A plurality of pivot fasteners 25 each is driven through the hole 231 into the inner edge of the slat 22 so as to pivotably secure the tilt rod 23 and the slats 22 together.

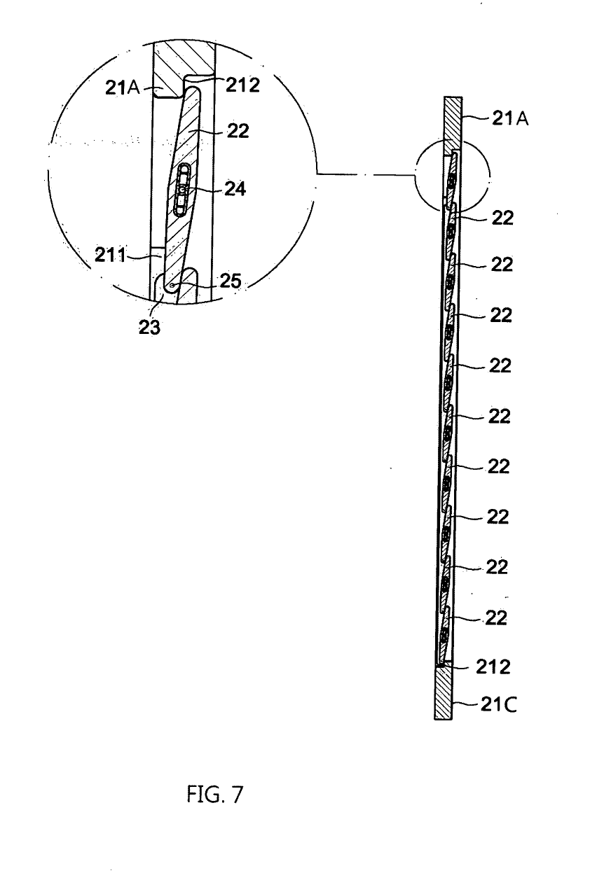

As shown in FIG. 7, the topmost slat 22 has its top edge being stopped by a horizontal shoulder 212 formed on an outer edge of the head 21A and the bottommost slat 22 has its bottom edge being stopped by another horizontal shoulder 212 formed on an inner edge of the sill 21C respectively when the louver 20 is closed. The provision of the shoulders 212 prevents the topmost and bottommost slats 22 from pivoting out of their desired positions. Moreover, the slats 22 are partially overlapped when the louver 20 is closed.

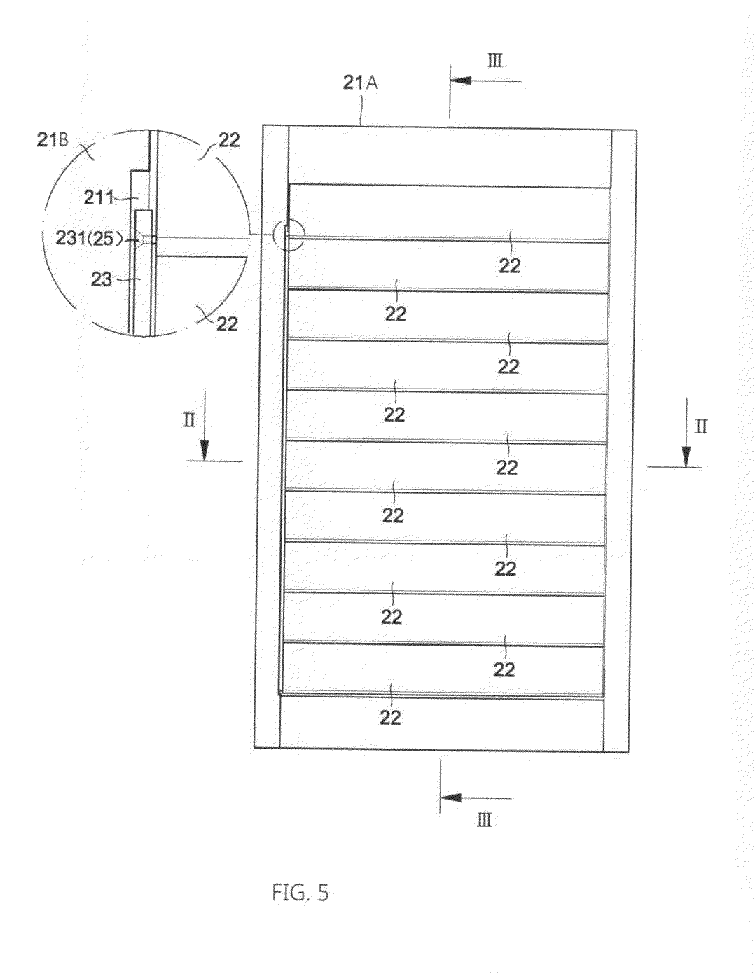

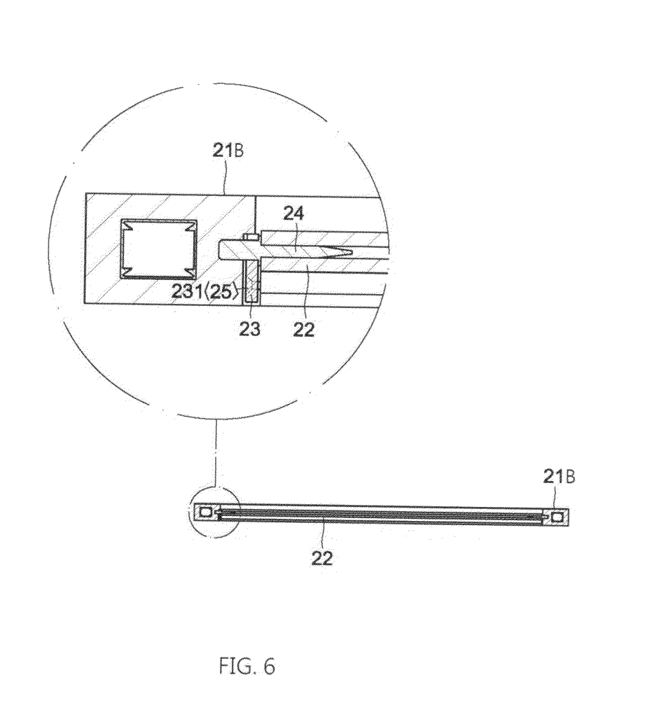

As shown in FIG. 5, the tilt rod 23 is received in the recess 211 when the louver 20 is closed. As further shown in FIG. 6, the tilt rod 23 is disposed on a plane slightly recessed relative to the left iamb 21B. This has the benefit of preserving an aesthetic appearance of the louver 20 when it is closed.

In addition, as shown in FIG. 5, there is a gap between top of the tilt rod 23 and top edge of the recess 211. A minimum amount of sunlight or rain may enter an interior area through the gap. For overcoming this, the tilt rod 23 and the recess 211 can be designed to be complimentary members of substantially the same size in other embodiments.

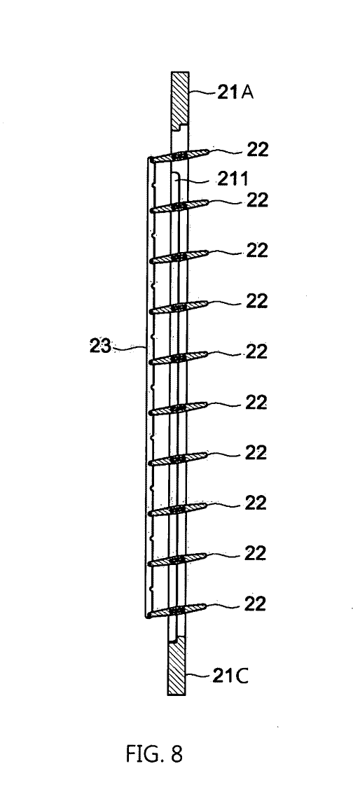

It is envisaged that a pivotal clockwise or counterclockwise movement of a single slat 22 by holding same will impart the pivotal clockwise or counterclockwise movement to the remaining slats 22 so as to either open or close the louver 20 (see FIGS. 7 and 8).

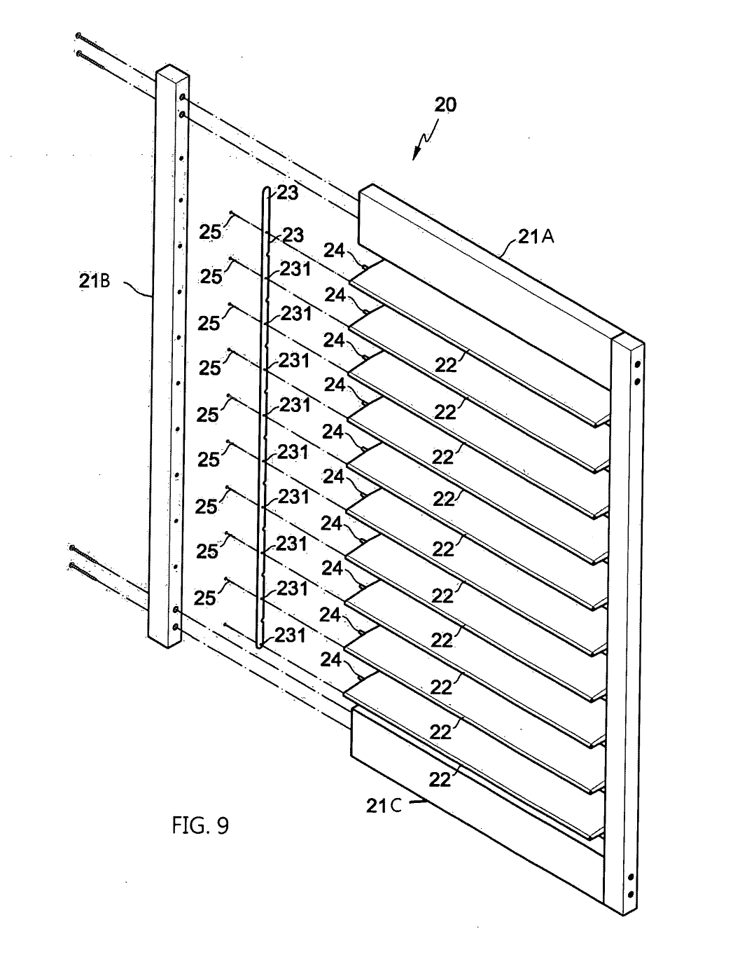

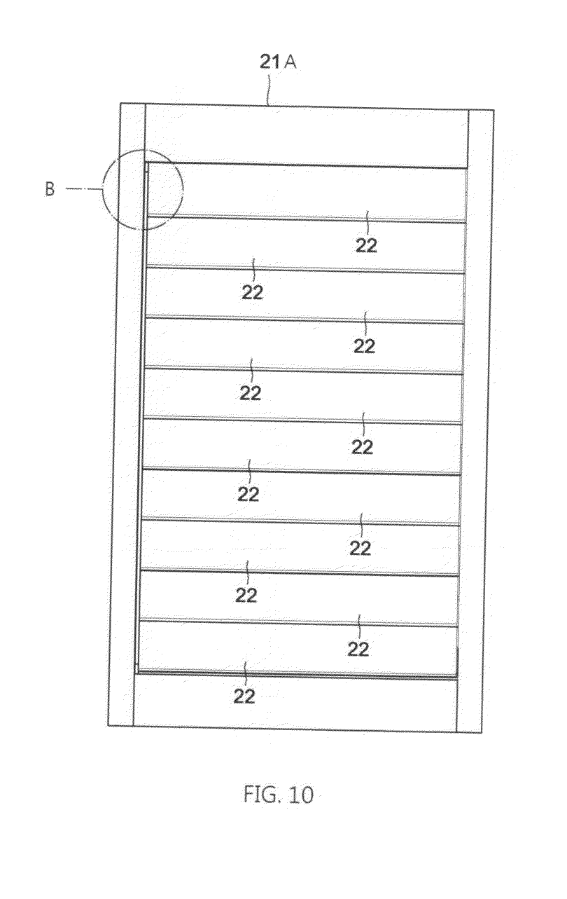

Referring to FIGS. 9 to 11, a louver 20 in accordance with a second preferred embodiment of the invention is shown. The characteristics of the second preferred embodiment are detailed below. The recess in the left iamb 21 B of the first preferred embodiment is eliminated. Further, the left ends of the slats 22 are not flush with the left ends of the head 21A and the sill 21C so as to allow the tilt rod 23 to receive in a space defined by the left iamb 21B, the left ends of the slats 22, the head 21A, and the sill 21C when the louver 20 is closed.

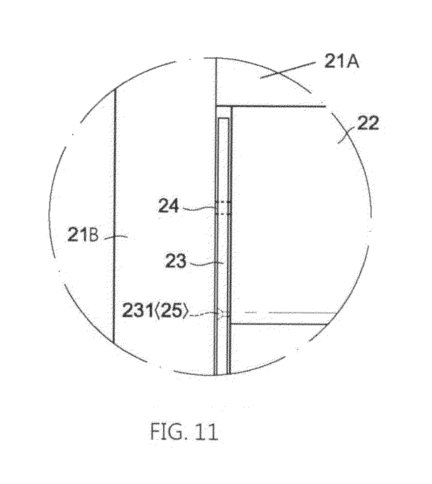

In addition, as shown in FIG. 11, there is a gap between top of the tilt rod 23 and bottom edge of the head 21A. A minimum amount of sunlight or rain may enter an interior area through the gap. For overcoming this, the tilt rod 23 can be lengthened to fill the gap in other embodiments.

Other components and pivotal movement of the slats 22 are the same as that described in the first embodiment. Therefore, its description is omitted herein for the sake of brevity.

While the tilt rod and the corresponding recess are provided in the left side of the louver, they can be provided in the right side of the louver in other embodiments.

Further, while the tilt rod and the corresponding recess are provided in the interior of a window, they can be provided in the exterior of the window in other embodiments.

It is envisaged that a pleasing aesthetic appearance can be obtained by louver of the invention since the tilt rod is disposed in a non-protrusion position after closing the louver. Specifically, the interior of the louver is substantially flat with no projecting components after closing.

While the invention herein disclosed has been described by means of specific embodiments, numerous modifications and variations could be made thereto by those skilled in the art without departing from the scope and spirit of the invention set forth in the claims.

1-3. (canceled)

4. A louver for installation in an opening in a wall comprising:
a head;
a sill;
two opposite jambs wherein one jamb has a longitudinal recess;
a plurality of parallel sloping slats disposed in a space defined by the head, the sill, and the jambs, each slat being pivotably secured to the jambs; and
a tilt rod pivotably secured to the slats,
wherein the tilt rod is received in the recess when the louver is closed.

5. A louver for installation in an opening in a wall comprising:
a head;
a sill;
two opposite jambs;
a plurality of parallel sloping slats disposed in a space defined by the head, the sill, and the jambs, each slat being pivotably secured to the jambs and having one end extending to a position being spaced from one jamb by a predetermined distance; and
a tilt rod pivotably secured to the slats,
wherein the tilt rod is received in a space defined by one jamb, one ends of the slats, the head, and the sill when the louver is closed.
